(19) United States
(12) Patent Application Publication
(10) Pub. No.: US 2016/0324151 A1
(43) Pub. Date: Nov. 10, 2016

(54) COMPOSITIONS AND METHODS OF FUMIGATION

(71) Applicant: HONEYWELL INTERNATIONAL INC., MORRISTOWN, NJ (US)

(72) Inventors: Andrew Joseph Poss, Kenmore, NY (US); Rajiv Ratna Singh, Getzville, NY (US); David Nalewajek, West Seneca, NY (US); Cheryl Cantlon, Clarence Center, NY (US)

(21) Appl. No.: 15/211,915

(22) Filed: Jul. 15, 2016

Related U.S. Application Data
(63) Continuation-in-part of application No. 14/978,436, filed on Dec. 22, 2015.
Application No. 14/978,436 is a division of application No. 13/651,565, filed on Oct. 15, 2012, now Pat. No. 9,232,788.
(60) Provisional application No. 62/194,015, filed on Jul. 17, 2015.
(60) Provisional application No. 61/554,623, filed on Nov. 2, 2011.

(51) Int. Cl. A01N 29/02

(52) U.S. Cl. CPC A01N 29/02

(57) ABSTRACT

Fumigation compositions and methods which utilize or comprise cis-1-chloro-3,3,3-trifluoropropene in amounts and under conditions effective to produce a substantial fumigation affect and preferably are essentially free of methyl iodide and/or are essentially free of any compound having a LD50 toxicty of less than about 50 mg/kg (oral, rat).

### CROSS-REFERENCE TO RELATED APPLICATIONS

The application is a continuation-in-part of and claims the priority benefit of co-pending U.S. application Ser. No. 14/978,436 filed on Dec. 22, 2015, currently pending, which in turn is a division of U.S. application Ser. No. 13/651,565, now U.S. Pat. No. 9,232,788, issued on Jan. 12, 2016, filed Oct. 15, 2012, which in turn claim priority benefit of Provisional Application 61/554,623, filed Nov. 2, 2011. Each of the applications referenced in this paragraph is incorporated herein by reference.

This application also claims the priority benefit of U.S. Provisional Application 62/194015, filed Jul. 17, 2015, which is incorporated herein by reference.

### BACKGROUND

1. Field of Invention

This invention generally relates to methods for killing or inhibiting growth of plants. More particularly, the invention relates to compositions and methods for substantially reducing or eliminating the growth of unwanted plant species, including especially in soil.

2. Background

The control of plant pathogens, nematodes and weeds is of central importance to the agriculture industry.

At the present time, methyl bromide (CH₃Br) is the most widely used and most universal fumigant in the world. It is used extensively for soil fumigation, as a commodity quarantine treatment (export and imports), to control a variety of pests on numerous crops, and as a structural fumigant for wood destroying pests. For a variety of environmental reasons, including ozone depletion concerns, the use of methyl bromide has become disfavored.

A known methyl bromide alternative is chloropicrin. However, while this substance has proved very effective as an inhibitor of plant diseases, it has limited effectiveness against nematodes and weeds. Telone (1,3-dichloropropene) is an excellent nematicide but generally performs poorly against weeds and diseases. Metam sodium and metam potassium can provide good control of weeds when placed properly in the soil bed, however research to evaluate modification of rate, placement, and improved application technology have not resolved all problems of inconsistent pest control. These alternatives are commonly applied as mixtures of two or more of the individual compounds in order to attempt to produce a broader spectrum product similar to methyl bromide.

Another compound that has been used in connection with fumigation applications in methyl iodide. Azeotropic and azeotrope-like compositions based on methyl iodide are disclosed, for example, in US 2012/0064208. These composition contain methyl iodide and at least one fluorocarbon or hydrofluorocarbon. Examples of fluorocarbons and hydrofluorocarbons suitable for use in the azeotropic or azeotrope-like compositions include 1-chloro-3,3,3 trifluoropropene (HCFC-1233xd); 2,2-dichloro-1,1,1-trifluoroethane (HCFC-123); 1,1,2,2-tetrafluoroethyl methyl ether (HFE245); cis-1,3,3,3-tetrafluoropropene (HFC-1234ze), (E)-1-chloro-3,3,3,-trifluoropropene (HFO-1233zd(E)), (Z)-1-chloro-3,3,3,-trifluoropropene (HFO-1233zd(Z)), 1,1,1,3,3-pentafluoropropane (HFC-245fa); 1,1,1,3,3-pentafluorobutane (HFC-365); 1,2-difluoroethane (HFC152); 1,2,2,3,3-pentafluoropropane (245ca); 1,2,2-trifluoroethane (HFC-143) and mixtures of these.

As new fumigants are introduced, their global warming potential (GWP) is also being scrutinized. Global warming potential (GWP) is a relative measure of how much heat a greenhouse gas traps in the atmosphere. It compares the amount of heat trapped by a certain mass of the gas in question to the amount heat trapped by a similar mass of carbon dioxide. A GWP is calculated over a specific time interval, commonly 20, 100 or 500 years. GWP is expressed as a factor of carbon dioxide (whose GMP is standardized to 1). For example, the 20 year GWP of methane is 56, which means if the same weights of methane and carbon dioxide were introduced into the atmosphere, that methane will trap 56 times more heat than the carbon dioxide over the next 20 years. Accordingly, it has also become desirable to develop new fumigant compositions which are more environmentally friendly with respect to global warming.

The fluorinated alkenes disclosed in U.S. Pat Nos. 3,510,503, 3,654,333, and 3.780,050 have been disclosed as controlling nematodes and insects when applied to the soil. More recently, the fluorinated alkenes hexafluoropropene and 1,1,3,3,3-pentafluoropropene have been disclosed in US 2013-0109570 as being effective as fumigants against a variety of different undesirable species, such as weeds, nematodes or pathogens. The compounds disclosed in the 570 publication are said to each have a GWP of less than 1.

While the ability of fumigant compositions and methods to eradicate and/or reduce undesirable species in soils and other environments is highly desirable, it is also highly desirable to develop compositions and methods that at the same time possess a high degree of ease and safety in handling and application. For example, applicants have come to appreciate that costly and time consuming precautions must be followed in the application of fumigant compositions that contain chemicals having relatively high levels of acute toxicity in order to prevent potentially harmful inhalation exposure of these chemicals to workers applying the compositions/materials. In addition, compositions/materials which include compounds having high levels of acute toxicity may also require longer periods of time before agricultural workers can reenter the treated field to ensure that compounds having high levels of acute toxicity will not be inhaled by those agricultural workers.

With respect to the compounds mentioned in US 2013-0109570, which is assigned to the assignee of the present application, applicants have come to appreciate that these compounds do in fact exhibit substantial effectiveness in fumigation applications and at the same time have a desirable environmental friendliness in terms of both ODP and GWP. However, the present applicants have also come to appreciate that despite these advantages and benefits, a need is left unsolved by these compositions and methods. More particularly, applicants have come to appreciate that improvements can be made in the safety and cost-effectiveness of fumigation compositions and methods while maintaining high levels of fumigation activity and low levels of both ODP and GWP. More specifically, it has been reported that a relatively high degree of acute toxicity is associated with fluorinated alkenes which have more than one fluorine substituent on a terminal, unsaturated carbon. See, for example, U.S. Pat. No. 7,534,366 at col. 2, lines 1-35. Applicants have come to appreciate that all of the fluoroalkene compounds described in each of U.S. Pat. Nos. 3,510,503, 3,654,333, and 3.780,050 and in US 2013-0109570 include in their molecular structure the —CR═CF2, where R is H or halogen. These are the types of compounds that the '366 patent describes as having high levels of acute toxicity.

Similarly, the use of methyl iodide-based compositions for fumigation has recently become a source of safety concern because of possible high levels of toxicity. For example, NIOSH considers methyl iodide to be a potential occupational carcinogen as defined by the OSHA carcinogen policy [29 CFR 1990], and this material has a current OSHA PEL of 5 ppm (28 mg/m3) and has a current (revised) Immediately Dangerous to Life or Health Concentrations (IDLH) of 100 ppm. As a consequence, NIOSH recommends as part of its carcinogen policy that the “most protective” respirators be worn for methyl iodide at concentrations above 2 ppm. Also, methyl iodide has a LD50 of 76 mg/kg (oral, rat).

Applicants have thus come to appreciate and recognize that there remains a need for an effective and environmentally friendly replacement for previously used fumigants, such as methyl bromide, but which are less costly and burdensome to use and apply, at least from a worker health and safety standpoint, than previously disclosed fluorinated olefins.

### SUMMARY

Fumigation compositions and methods which utilize or comprise cis-1-chloro-3,3,3-trifluoropropene (also referred to as either cis-HFO-1233zd or HFO-1233zd(Z)), and preferably in preferred embodiments such compositions that are essentially free of methyl iodide, have been found by applicants to satisfy one or more of the needs identified above, and preferably to at once satisfy each of the needs described above. As used herein, the term “essentially free of methyl iodide” means that the fumigant compositions, or the one or more active components taken together, contain less than 2000 ppm of methyl iodide, more preferably less than 1000 ppm of methyl iodide, and even more preferably less than about 500 ppm of methyl iodide,

Applicants have discovered that cis-HFO-1233zd, especially and preferably when present in compositions in amounts and used under conditions as described herein, exhibits high levels of effectiveness in many important fumigation applications while at the same time presenting a substantially lower level of acute toxicity than the previously disclosed fluorinated alkenes and/or other previously used fumigant compositions, including those which include methyl iodide. Accordingly, certain embodiments of the present invention provide fumigation compositions which comprise, and in certain embodiments consist essentially of or consist of, HFO-1233zd (Z) in amounts and under conditions effective to produce a substantial fumigation affect, preferably and particularly when applied to soil. In preferred embodiments the present compositions are essentially free of any components that have a high LD50 toxicty. As used herein, the term “high LD50 toxicty” means acute toxicity, as measured by LD50, of less than about 50 mg/kg (oral, rat). As used herein, the term “essentially free any components that have a high LD50 toxicty” means that the fumigant compositions or the one or more active components taken together, contain less than 2000 ppm of any such component, more preferably less than 1000 ppm of any such component, and even more preferably less than about 500 ppm of any such component.

In preferred embodiments the present compositions are essentially free of any components that have an LD50 toxicty of less than about 80 mg/kg (oral, rat), and even more preferably are substantially free of any components that have an LD50 toxicty of less than about 150 mg/kg (oral, rat). As used herein, the term “essentially free any components that have a LD50 toxicty” means that the fumigant compositions or the one or more active components taken together contain less than 2000 ppm of any such component, more preferably less than 1000 ppm of any such component, and even more preferably less than about 500 ppm of any such component.

In embodiments of the present invention in which the fumigant composition comprises a mixture of components, the mixture is in preferred embodiments a zeotropic composition. For zeotropic compositions, it is also generally preferred that the composition is essentially free of methyl iodide and/or essentially free of any components that have a high LD50 toxicty and/or are essentially free of any components that have an LD50 toxicty of less than about 80 mg/kg (oral, rat), and even more preferably are substantially free of any components that have an LD50 toxicty of less than about 150 mg/kg (oral, rat).

In certain preferred embodiments, the present invention is directed to methods of fumigating soils containing weed seeds, comprising applying to the soil a fumigant containing HFO-1233zd (Z), wherein the applying step comprises applying the fumigant to the soil, preferably in certain embodiments in a liquid form, and in an amount effective to ensure that less than about 20% by number, more preferably less than about 10% by number, and even more preferably less than about 5% by number of the weed seeds present in the soil at the time of application germinate. In certain preferred embodiments, the applying method comprises applying the fumigant of the present invention to the soil in an amount greater than about 10 microliliter (10⁻⁶ liters) of fumigant composition per milliliter of soil (10⁻³ liters), (μl/ml), more preferably in an amount greater than about 15 μl/ml, and even more preferably in an amount of from greater than about 5 μl/ml to less than about 20 μl/ml. Preferably in such embodiments, the weeds contained in the soil include broadleaf weed species (represented by Abutilon theophrastic Medik.) and/or a grass weed species (represented by Loliium multiflorum Lam.).

In preferred embodiments, the present invention is directed to methods of fumigating soils, preferably reducing or eradicating undesirable species, including weed seeds, comprising (i) one or more active compounds and (ii) optionally carrier for said one or more active compounds, wherein said one or more active compounds consists essentially of cis-1-chloro-3,3,3-trifluoropropene (HFCO-1233zd(Z)).

In certain preferred embodiments, the compositions of the present invention comprise HFO-1233zd (Z) in amounts effective to have a substantial fumigation affect when applied to soil, preferably in liquid form, and do not contain any substantial amount of fluorinated alkene compounds having a terminal, unsaturated carbon with two halogen substituents. In preferred embodiments, the compositions of the present invention do not have more than about 5% by weight, even more preferably do not have more than about 2% by weight, and even more preferably do not have more than about 1% by weight, an preferably less than about 100 ppm by weight and even more preferably less than about 50 ppm by weight, of halogentated alkene compounds having an unsaturated terminal carbon with two halogen substituents. In certain preferred embodiments of the present invention, the compositions are substantially free of halogentated alkene compounds having an unsaturated terminal carbon with two halogen substituents. As the term is used herein, “substantially free” means less than about 500 ppm by weight of the halogentated alkenes in the composition are compounds having an unsaturated terminal carbon with two halogen substituents.

### BRIEF DESCRIPTION OF THE DRAWINGS

FIG. 1 is a plot of the data from Comparative Example 1.

FIG. 2A is a plot of data from Comparative Example 2.

FIG. 2B is a plot of data from Comparative Example 2.

FIG. 3A is a plot of data from Comparative Example 3.

FIG. 3B is a plot of data from Comparative Example 3.

FIG. 4 is a plot of the data from Comparative Example 4.

### DETAILED DESCRIPTION OF PREFERRED EMBODIMENTS

The fumigant composition of the present invention comprises, consists essentially of or consists of cis-1-chloro-3,3,3-trifluoropropene (cis-HFO-1233zd or HFCO-123zd(Z)), which has the following structure:

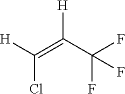

HFCO-1233zd(Z) has a desirably low atmospheric lifetime of time of only 11 days, a global warming potential of less than about 1, and a negligible ozone depletion potential. At the same time, HFCO-1233zd(Z) has been found to have substantial effectiveness in fumigant applications, especially fumigation of soil to eradicate or reduce the germination and/or growth of unwanted plant life, while avoiding high levels of acute toxicity associated with prior fumigants, including prior haloolefin fumigants.

In general, the fumigant compositions of the present invention may be used against a variety of different undesirable species, such as weeds, nematodes or pathogens. In some embodiments, the present fumigant compositions may be used against a variety of different insects, including but not limited to termites, cockroaches, mites and bed bugs. In some embodiments, these fumigant compositions may be used against animals such as gophers, mice, moles, rats and other rodent pests.

The present fumigant compositions may be used in a variety of different treatment zones. Broadly, a treatment zone is a surface, space or other volume that contains undesirable species. In some embodiments, for example, the treatment zone may be a building such as a warehouse or store or a vehicle such as a tractor trailer or a rail car. In highly preferred embodiments of the present invention, the treatment zone comprises a soil, and even more preferably a field of soil, containing unwanted plant material, including and preferably unwanted plant seeds.

### Fumigant Compositions

The compositions of the present invention comprises HFO-1233zd(Z) in an initial mixture (e.g., prior to diluting, preferably with water, into a use solution) in an amounts over a wide range in order to satisfy the particular needs of the user in view of the teachings contained herein. In certain preferred embodiments, the fumigant compositions contain HFO-1233zd(Z) in amount from greater than zero to about 1 weight percent (wt. %). In certain preferred embodiments, HFO-1233zd(Z) is present in the fumigant composition in amounts of from about 1 wt. % to about 99 wt. %, and in other preferred embodiments in amounts of from about 1 wt. % to about 95 wt. %. In certain preferred embodiments, HFO-1233zd(Z) is present in the fumigant compositon in amounts of from about 1 wt. % to about 85 wt. %, while in other embodiments it is present in amounts of from about 1 wt. % to about 75 wt. % or from about 1 wt. % to about 50 wt. %., and in yet further embodiments in amounts of from about 1 wt. % to about 40 wt. %. In certain preferred embodiments, HFO-1233zd(Z) is present in the fumigant composition in amounts of for from about 1 wt. % to about 30 wt. %. HFO-1233zd(Z) may further be present within any range deliminated by any pair of the foregoing values set forth in this paragraph.

In addition to HFO-1233zd(Z), the fumigant compositions may also include at least one additional active ingredient. In certain embodiments which may be somewhat less preferred from the perspective of the toxicity of the composition and/or the safety of the workers and others exposed to the composition, suitable co-actives for the fumigant compositions include, but are not limited to, hexafluorpropene, methyl iodide, chloropicrin, acrolein, 1,3-dichloropropene, dimethyl disulfide, furfural, metham sodium and propylene oxide.

In other embodiments which are more preferred in some cases in which low toxicity and/or hazard associated with the composition, and/or in which the safety of the workers and others exposed to the composition is considered especially important, the suitable co-actives for the fumigant compositions include compositions include hexafluorpropene, chloropicrin, 1,3-dichloropropene, dimethyl disulfide, metham sodium and propylene oxide.

In other embodiments which are more preferred in some cases in which low toxicity and/or hazard associated with the composition, and/or in which the safety of the workers and others exposed to the composition is considered especially important, the suitable co-actives for the fumigant compositions include compositions include, and is preferably selected from the group consisting of, chloropicrin, dimethyl disulfide, and copies of these.

Methyl iodide can be present in the initial mixture in any suitable amount, including for example, in an amount as low as about 5 wt. %, in an amount as low as about 15 wt. % or in an amount as low as about 25 wt. %. Methyl iodide can be present in the initial mixture in an amount as high as about 50 wt. %, in an amount as high as about 60 wt. % or in an amount as high as about 70 wt. %. Methyl iodide may further be present within any range deliminated by any pair of the foregoing values set forth in this paragraph.

The fumigant compositions according to embodiments of the present invention may further include various additives. In one embodiment, especially and preferably when the fumigant composition is a liquid composition and even more preferably an aqueous composition, the composition may include at least one surfactant. Suitable surfactants for use in fumigant compositions can be ionic surfactants or non-ionic surfactants. Non-ionic surfactants that can be suitable in fumigant compositions include, but are not limited to: Arkopal™ (a nonylphenol ethoxylate), Cetomacrogol™ 1000 (a polyethylene glycol), cetostearyl alcohol, cetyl alcohol, cocamide DEA, cocamide MEA, decylglucoside, glyceryl laurate, lauryl glucoside, narrow range ethoxylates, nonoxynols, NP-40, octaethylene glycol monododecyl ether, octyl glucoside, ( )eyl alcohol, pentaethylene glycol, monododecyl ether, poloxamer, polyglycerol polyricinoleate, polysorbate, polysorbate 20, polysorbate 40, polysorbate 60, polysorbate 80, sorbitan monostearate, sorbitan tristearate, stearyl alcohol, Triton™ X-100 (polyethylene oxide chain with an aromatic hydrocarbon group), and Tween™ 80 (a polysorbate). In one specific example, the surfactant can be a polysorbate, which can be polysorbate 20, polysorbate 40, polysorbate 60 or polysorbate 80.

The surfactant can be included in an amount that is as low as about 0.1 wt. %, in an amount as low as about 3 wt. % or in an amount as low as about 5 wt. %. The surfactant can be included in an amount that is as high as about 15 wt. %, in an amount as high as about 30 wt. % or in an amount as high as about 50 wt. %. The surfactant may further be present within any range deliminated by any pair of the foregoing values set forth in this paragraph. In certain highly preferred embodiments, the compositions comprise surfactant in an amount of from about 0.1 wt % to 50 wt %, more preferably from about 3 wt % to about 30 wt %, and most preferably in an amount of from about 4 wt % to about 7 wt %.

In some embodiments, the compositions comprise a carrier, preferably in certain embodiments a solvent carrier and said HFO-1233zd(Z). In certain preferred embodiments, the carrier comprises at least one C3-C4 hydrofluorocarbon olefin or at least one hydrochlorofluorocarbon olefin which preferably have a combination of desirable environmental and functional properties, but which in certain highly preferred embodiments do not have an unsaturated terminal carbon with two halogen substituents. For example, environmentally, the carrier solvents can have an ozone depletion potential (ODP) that is zero or about zero. Carrier solvents may also have a low global warming potential, which can preferably be less than or equal to about 10 relative to CO2. Functionally, carrier solvents are preferably volatile, non-toxic, and non-flammable. Co-solvents for use with the present compositions may include mixtures of tetrafluoropropenes, hexafluorobutenes and chlorotrifluoropropenes, once again preferably wherein such co-solvents are substantially free of alkene compounds having an unsaturated terminal carbon with two halogen substituents. The carrier solvents can include an azeotropic or azeotrope-like mixture of the at least one C3-C4 hydrofluorocarbon.

In certain preferred embodiments, the fumigant compositions comprise from about 1 wt % to about 99 wt % carrier, preferably solvent carrier, and from about 1 wt % to about 99 wt % of HFO-1233zd(z). In certain preferred embodiments, the fumigant compositions comprise from about 1 wt % to about 50 wt % carrier, preferably solvent carrier, and from about 50 wt % to about 99 wt % of HFO-1233zd(z). In certain preferred embodiments, the fumigant compositions comprise from about 1 wt % to about 5 wt % carrier, preferably in certain embodiments solvent carrier, and from about 95 wt % to about 99 wt % of HFO-1233zd(z).

For safety purposes, the fumigant composition may include an odorant such as banana oil or chloropicrin.

### Methods of Fumigating

Applicants believe that in view of the teachings contained herein those skilled in the art will be able to utilize fumigant compositions of the present invention in a wide variety of application methods to reduce and preferably substantially eradicate an unwanted species of plant or animal from a treatment zone, and all such methods and application techniques are within the broad scope of the present invention.

The present methods of reducing or eradicating undesirable species from soil may in preferred embodiments comprise: (a) contacting the soil with a fumigant composition comprising: (i) one or more active compounds and (ii) optionally carrier for said one or more active compounds, wherein said one or more active compounds comprises at least about 10% by weight of cis-1-chloro-3,3,3-trifluoropropene (HFCO-1233zd(Z)), and an additional compound selected from hexafluoropropene, chloropicrin, acrolein, 1,3-dichloropropene, dimethyl disulfide, furfural, propylene oxide and metham sodium.

Some methods of the present invention comprise reducing or eradicating undesirable species from soil by steps that comprise: (a) contacting the soil with a fumigant composition comprising: (i) one or more active compounds and (ii) optionally carrier for said one or more active compounds, wherein said one or more active compounds comprises at least about 10% by weight of cis-1-chloro-3,3,3-trifluoropropene (HFCO-1233zd(Z)) and chloropicrin. In preferred aspects of such embodiment, the chloropicrin is present in an amount of from greater than zero to about 1% by weight, and even more preferably from about 0.15 to about 0.7%, of based on the total weight of the one or more active compounds. In each of the embodiments described in the present application, and in particular in this paragraph, the one or more active compounds comprises HFCO-1233zd(Z) in an amount of at least about 40%, more preferably at least about 50%, and more preferably in some embodiment at least about 99% by weight based on the total weight of the one or more active compounds. Furthermore, in each of the embodiments of the present invention as disclosed herein, including particularly in each of embodiments as described herein, the the undesirable species include one or more of weeds, nematodes or pathogens.

Some methods of the present invention comprise reducing or eradicating undesirable species from soil by steps that comprise: (a) contacting the soil with a zeotropic fumigant composition comprising: (i) one or more active compounds and (ii) optionally carrier for said one or more active compounds, wherein said one or more active compounds comprises at least about 10% by weight of cis-1-chloro-3,3,3-trifluoropropene (HFCO-1233zd(Z)).

Some methods of the present invention comprise reducing or eradicating undesirable species from soil by steps that comprise: (a) contacting the soil with a zeotropic fumigant composition comprising: (i) one or more active compounds and (ii) optionally carrier for said one or more active compounds, wherein said one or more active compounds comprises at least about 10% by weight of cis-1-chloro-3,3,3-trifluoropropene (HFCO-1233zd(Z)) wherein said fumigant composition is: (i) essentially free of methyl iodide; and/or essentially free of any components that have a high LD50 toxicty; and/or are essentially free of any components that have an LD50 toxicty of less than about 80 mg/kg (oral, rat); and/or are essentially free of any components that have an LD50 toxicty of less than about 150 mg/kg (oral, rat).

Some methods of the present invention comprise reducing or eradicating undesirable species from soil by steps that comprise: (a) contacting the soil with a fumigant composition comprising: (i) one or more active compounds and (ii) optionally carrier for said one or more active compounds, wherein said one or more active compounds comprises at least about 10% by weight of cis-1-chloro-3,3,3-trifluoropropene (HFCO-1233zd(Z)) and 1,3-dichloropropene.

Some methods of the present invention comprise reducing or eradicating undesirable species from soil by steps that comprise: (a) contacting the soil with a fumigant composition comprising: (i) one or more active compounds and (ii) optionally carrier for said one or more active compounds, wherein said one or more active compounds comprises at least about 10% by weight of cis-1-chloro-3,3,3-trifluoropropene (HFCO-1233zd(Z)) and dimethyl disulfide.

Some methods of the present invention comprise reducing or eradicating undesirable species from soil by steps that comprise: (a) contacting the soil with a fumigant composition comprising: (i) one or more active compounds and (ii) optionally carrier for said one or more active compounds, wherein said one or more active compounds comprises at least about 10% by weight of cis-1-chloro-3,3,3-trifluoropropene (HFCO-1233zd(Z)) and metham sodium.

Some methods of the present invention comprise reducing or eradicating undesirable species from soil by steps that comprise: (a) contacting the soil with a fumigant composition comprising: (i) one or more active compounds and (ii) optionally carrier for said one or more active compounds, wherein said one or more active compounds comprises at least about 10% by weight of cis-1-chloro-3,3,3-trifluoropropene (HFCO-1233zd(Z)) and propylene oxide.

In certain preferred embodiments the compositions of the present invention are in the form such that the compound cis-1-chloro-3,3,3-trifluoropropene contacts the soil containing the unwanted species, preferably plant species (including seeds thereof) in liquid form. In this regard it is intend that liquid form of the fumigant compositions include compositions in which the cis-1-chloro-3,3,3-trifluoropropene is dissolved, either as a gas or liquid, in a liquid carrier or solvent. Of course, embodiments in which the fumigant compositions include cis-1-chloro-3,3,3-trifluoropropene as a gas, the cis-1-chloro-3,3,3-trifluoropropene can be used alone or is used together with a carrier gas. In certain embodiments, the methods comprise exposing the soil to a liquid and/or gas stream comprising, and preferably comprising at least in a major proportion by volume of active ingredients, cis-1-chloro-3,3,3-trifluoropropene. In certain embodiments, the fumigant compositions of the present invention are applied to soil or structures as part of a solution or dispersion in the carrier, preferably in certain embodiments in which the carrier comprises water. The fumigant composition may be applied by a number of different procedures that are currently employed for soil and structural treatments.

In some embodiments, soil fumigant may utilize either shank injection or drip irrigation. In shank injection fumigation, the chemical fumigant, preferably in liquid form, is preferably applied to the soil by injection through hollow shanks that are pulled through the soil, either at shallow depths followed by plastic mulch film application, or at deep depths followed by soil compaction.

Application of the chemical fumigant, preferably in liquid form, via drip irrigation preferably involves introducing and dispersing the chemical fumigant through an existing irrigation system. This provides an advantage of minimizing potential exposure to workers, as this can be done without workers in the field, although those skilled in the art will appreciate that one advantage of preferred methods is that there is less of a need to minimize worker exposure, compared to prior, compositions and methods because of the low acute toxicity levels associated with the preferred compositions of the present invention.

The irrigation system may include one or more dripper lines having a plurality of emitters therein. The emitters, also known as drippers, can be of any suitable type, including for example pre-punched holes or porous pipe. The emitters can be formed as an integral part of a dripperline, or can be separately produced and installed on or in the one or more dripperlines. The emitters can be spaced apart at any suitable distance, including for example, from about 8 inches apart to about inches apart (from 200 mm to 600 mm apart).

In some embodiments, the one or more dripperlines can be placed below the soil that is to be fumigated. Application of the fumigant composition to the soil can include providing pressure to cause the fumigant composition to flow through the one or more dripperlines, preferably in gaseous and/or liquid form, and exit the one or more dripperlines through the plurality of emitters to contact and flow into the soil. Alternatively, the fumigants may be applied to the soil by tractor mounted injectors, manually in canisters or as a gas through lay-flat tubing.

The behavior of the fumigant compositions in use is a function of one or more many possible properties their water solubility, volatility, hydrolysis and degradation rates, and their sorption to soil organic matter and clay. The physical and chemical properties of the fumigants, such as: water solubility, vapor pressure, boiling point, Henry's constant and half life in soil, generally will impact how fumigant compositions behave in the soil-air-water system. The efficacy of a compound or a composition as fumigant can be influenced by a large number of performance interactions with the soil systems being treated, including for example distribution patterns in soils, and these performance interactions are generally not predictable in advance of testing. Without being bound by or to any particular theory of operation, it is believed that fumigant effectiveness in at least some applications may be related to the ability of fumigant to attain high concentrations in the pest-infested zone for a sufficient period of time to at least substantially reduce the growth of the unwanted species while at the same time leave the soil in sufficiently short time to not become a permanent or even semi-permanent contaminent in the soil.

For structural fumigation the chemicals may be heated to a gas before introduction within a building, chamber, vehicle or other space or structure. The space or structure is preferably sealed with a tarpaulin, fumigant tape or gas impermeable sheeting. In some embodiments, structural fumigant, particularly for rodents, involves sealing the structure as tightly as possible. In some embodiments, a 2 to 4 mil polyethylene cover may be used to wrap the structure before providing the fumigant composition. In some embodiments, the structure may subsequently be aerated to remove the fumigant composition.

Stacked commodities may be treated by draping the commodities with a gas-impermeable tarp or sheet that can be sealed to an impermeable surface (such as a concrete floor) using, for example, sand-filled tubes. After sufficient fumigant composition has been released under the tarp, the space may be aerated to remove remaining fumigant composition.

The fumigant compositions can be prepared by combining the HFCO-1233zd(Z), one or more optional co-active components, at least one surfactant and a carrier, such as water in certain embodiments, to form a fumigant composition. The fumigant composition can be a heterogenous mixture, a homogeneous mixture, a solution, a dispersion, an emulsion and any combination of these, and those skilled in the art will be able to prepare and utilize such forms of the present invention as needed depending on the particular application in view of the teachings contained herein. In one example, the fumigant compositions can be formed by mixing the components at a temperature at or below about 60° F. (15.5° C.).

Thus, one aspect the present invention provides use as a fumigant of a composition consisting essentially of HFCO-1233zd(Z). In other embodiments of this use, fumigant composition comprises at least about 10% by weight of HFCO-1233zd(Z) and an additional compound selected from hexafluoropropene, chloropicrin, acrolein, 1,3-dichloropropene, dimethyl disulfide, furfural, propylene oxide and metham sodium.

### Application Techniques

The fumigant composition may be applied to soil or structures according to the techniques and methods know to those skilled in the art for soil and structure fumigation, including as part of an aqueous solution or dispersion.

In some embodiments, soil fumigant may utilize either shank injection or drip irrigation. In shank injection fumigant, the chemical fumigant is applied to the soil by injection through hollow shanks that are pulled through the soil, either at shallow depths followed by plastic mulch film application, or at deep depths followed by soil compaction.

Application of the chemical fumigant via drip irrigation involves introducing and dispersing the chemical fumigant through an existing irrigation system. This provides an advantage of minimizing potential exposure to workers, as this can be done without workers in the field.

The irrigation system may include one or more dripperlines having a plurality of emitters therein. The emitters, also known as drippers, can be of any suitable type, including for example pre-punched holes or porous pipe. The emitters can be formed as an integral part of a dripperline, or can be separately produced and installed on or in the one or more dripperlines. The emitters can be spaced apart at any suitable distance, including for example, from about 8 inches apart to about 24 inches apart (from 200 mm to 600 mm apart).

In some examples, the one or more dripperlines can be placed below the soil that is to be fumigated. Application of the fumigant composition to the soil can include providing pressure to cause the fumigant composition to flow through the one or more dripperlines and exit the one or more dripperlines through the plurality of emitters to contact and flow into the soil. Alternatively, the fumigants may be applied to the soil by tractor mounted injectors, manually in canisters or as a gas through lay-flat tubing.

Applicants have found that the fumigant compositions of the present invention exhibit behaviors that are desirable for fumigant applications. In additions to the ability of the present compositions to kill or destroy the unwanted species, the present compositions are advantageous because of other properties that enhance use in these applications. Although applicants do not wish to be bound by an particular theory of operation, it is believed that the cisHFCO-1233zd according to the present invention, and the compositions in which it is contained, have properties such as water solubility, volatility, hydrolysis and degradation rates, sorption to soil organic matter and clay, that make the present composition highly advantageous in fumigant application. Moreover, it is believed that the physical and chemical properties of the present fumigant compositions, such as vapor pressure, boiling point, Henry's constant and half life in soil interact in unpredictable ways that results in excellent fumigant behavior in the soil-air-water system. The efficacy of the present fumigant compositions is thus believed to derive, at least in part, from its excellent distribution patterns in soils and applications that maximize concentrations in the pest-infested zone.

For structural fumigation the chemicals may be heated to a gas before introduction within a building, chamber, vehicle or other space or structure. The space or structure is preferably sealed with a tarpaulin, fumigant tape or gas impermeable sheeting. In some embodiments, structural fumigant, particularly for rodents, involves sealing the structure as tightly as possible. In some embodiments, a 2 to 4 mil polyethylene cover may be used to wrap the structure before providing the fumigant composition. In some embodiments, the structure may subsequently be aerated to remove the fumigant composition.

Stacked commodities may be treated by draping the commodities with a gas-impermeable tarp or sheet that can be sealed to an impermeable surface (such as a concrete floor) using, for example, sand-filled tubes. After sufficient fumigant composition has been released under the tarp, the space may be aerated to remove remaining fumigant composition.

### EXAMPLES

As demonstrated by Ohr, (Plant Disease 1996, 731-735) and concluded by Zhang (Pestic. Sci. 1998, 53, 71-79), weeds are generally more resistant to fumigation than nematodes or most soil-borne plant-pathogenic fungi. A broadleaf weed species (Abutilon theophrastic Medik.) and a grass weed species (Loliium multiflorum Lam.) can be used as a general indictor for most soil pests in fumigation experiments. Accordingly, in the examples which follow, fumigation tests have been conducted by applicants with HFO-1233zd(Z) in the broadleaf species Abutilon theophrastic Medik. and the grass weed species Loliium multiflorum.

Seeds from the broadleaf species Abutilon theophrastic Medik. or velvet leaf and the grass weed species Loliium multiflorum Lam. or Italian rye grass were used in all germination experiments. A single batch of seeds for each species was used and Abutilon theophrastic Medik. seeds were scarifrid with 55° C. water for two days to induce germination. Scotts premium topsoil was used as the soil in all experiments. The topsoil was placed in a vacuum oven at 110° C. for 7 days to sterilize the soil and remove all moisture.

### Comparative Example 1

Fifteen seeds of each species were placed together with 50 mL (10⁻³ liters) (approximately 30 grams) of soil and 6 mL of water into a 500 mL pressure vessel. The vessels were sealed and evacuated prior to the addition of the seeds and soil. Preparatory to filling, the vessels were brought up to atmospheric pressure by the addition of air. The materials as described above were added to the vessel and then thoroughly mixed. The vessel was placed horizontally on the laboratory bench and maintained at ambient temperature for 2 days. After 48 hours, the contents of the vessel were transferred to plastic sterile Petri dishes containing 7 mL of water. The Petri dishes were sealed with parafilm and incubated in the laboratory at ambient temperature. After 10 days, the number of germinated seeds were counted. Fourteen of the Abutilon theophrastic Medik seeds germinated (more than 90%) germinated and fifteen of the Loliium multiflorum Lam seeds germinated (100%).

### Example 1

The procedure described in Comparative Example 1 is repeated, expect that the fumigant compositions of the present invention were added to the soil in the form of a liquid consisting of HFCO-1233zd(Z) was added to the soil by direct injection after soil is added to the vessel. The amount of liquid in microliters (10⁻⁶ liters) are indicated in Table 1 below.

TABLE 1
Germination Results for cis-HFO-1233zd

| | SEED GERMINATION | |
|---|---|---|
| | Abutilon | Loliium |
| | theophrastic | multiflorum |
| Volume 1233zd(Z) | Medik. | Lam. |

| μl | μl/Ml dry soil | Number | % | Number | % |
|---|---|---|---|---|---|
| 10 | 0.2 | 14 | 93 | 10 | 67 |
| 250 | 5 | 13 | 87 | 9 | 60 |
| 500 | 10 | 11 | 73 | 7 | 47 |
| 1000 | 20 | 0 | 0 | 0 | 0 |

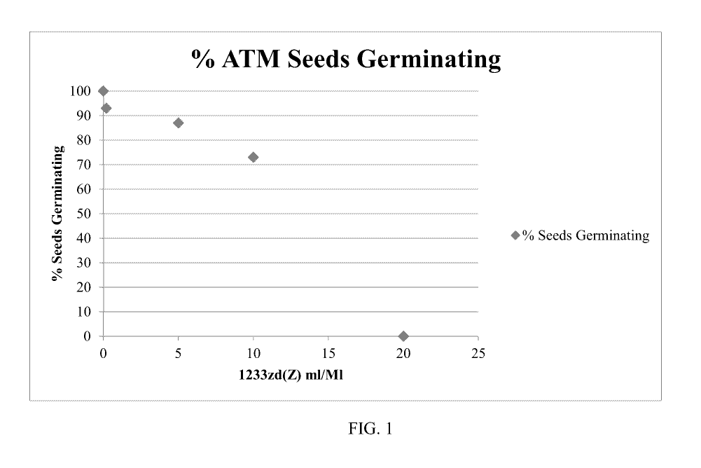

The experimental results showing the data above in terms of percentage of seeds germinating based on μl/MI dry soil are illustrated in FIG. 1.

### Comparative Example 2

The procedure described in Example 1 is repeated, expect that the liquid added was HFCO-1233zd(E). The results are reported in Table 2 below.

TABLE 2
Germination Results for trans-HFO-1233zd

| | SEED GERMINATION | |
|---|---|---|
| | Abutilon | Loliium |
| | theophrastic | multiflorum |
| Volume 1233zd(E) | Medik. | Lam. |

| μl | μl/Ml dry soil | Number | % | Number | % |
|---|---|---|---|---|---|
| 10 | 0.2 | 14 | 93 | 15 | 100 |
| 250 | 5 | 14 | 93 | 15 | 100 |
| 500 | 10 | 15 | 100 | 15 | 100 |
| 1000 | 20 | 15 | 100 | 15 | 100 |

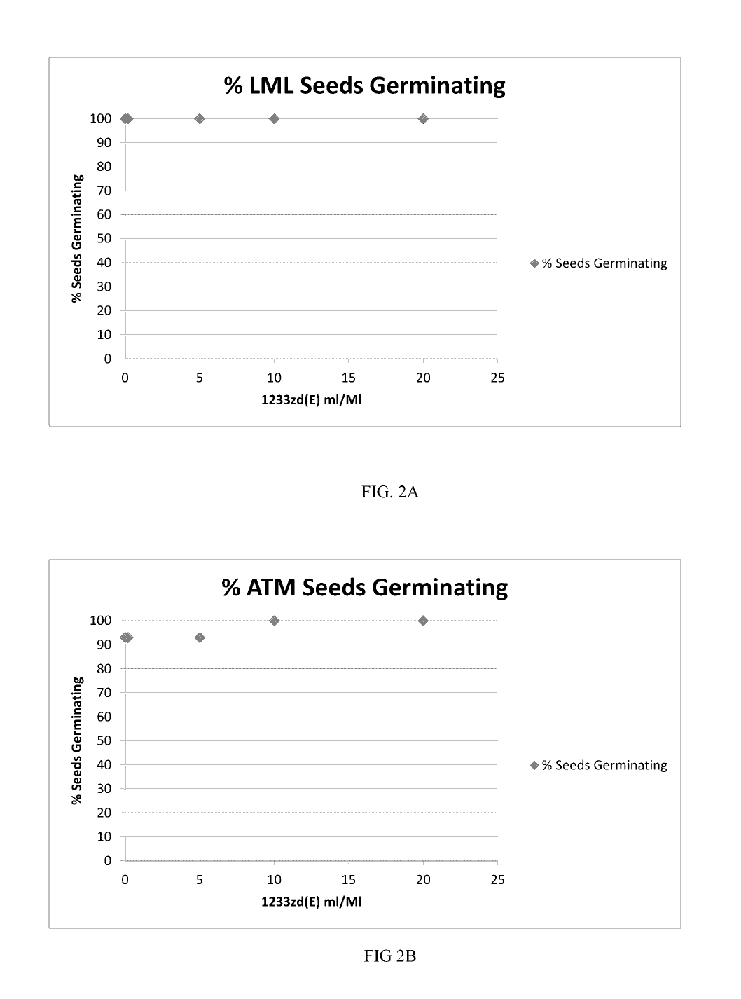

As can be seen from the results above, the 1233zd(E) showed little or no fumigation activity toward either the Abutilon theophrastic Medik seeds or the Loliium multiflorum Lam seeds in these tests, This is illustrated by the graphs of the data illustrated in FIGS. 2A and 2B.

### Comparative Example 3

The procedure described in Example 1 is repeated, expect that the liquid material added was HFO-1234ze(E). The results are reported in Table 3 below.

TABLE 3
Germination Results for trans-HFO-1234ze

| | SEED GERMINATION | |
|---|---|---|
| | Abutilon | Loliium |
| | theophrastic | multiflorum |
| Volume 1234ze(E) | Medik. | Lam. |

| μl | μl/Ml dry soil | Number | % | Number | % |
|---|---|---|---|---|---|
| 10 | 0.2 | 15 | 100 | 15 | 100 |
| 250 | 5 | 14 | 93 | 14 | 93 |
| 500 | 10 | 14 | 93 | 14 | 93 |
| 1000 | 20 | 15 | 100 | 14 | 93 |

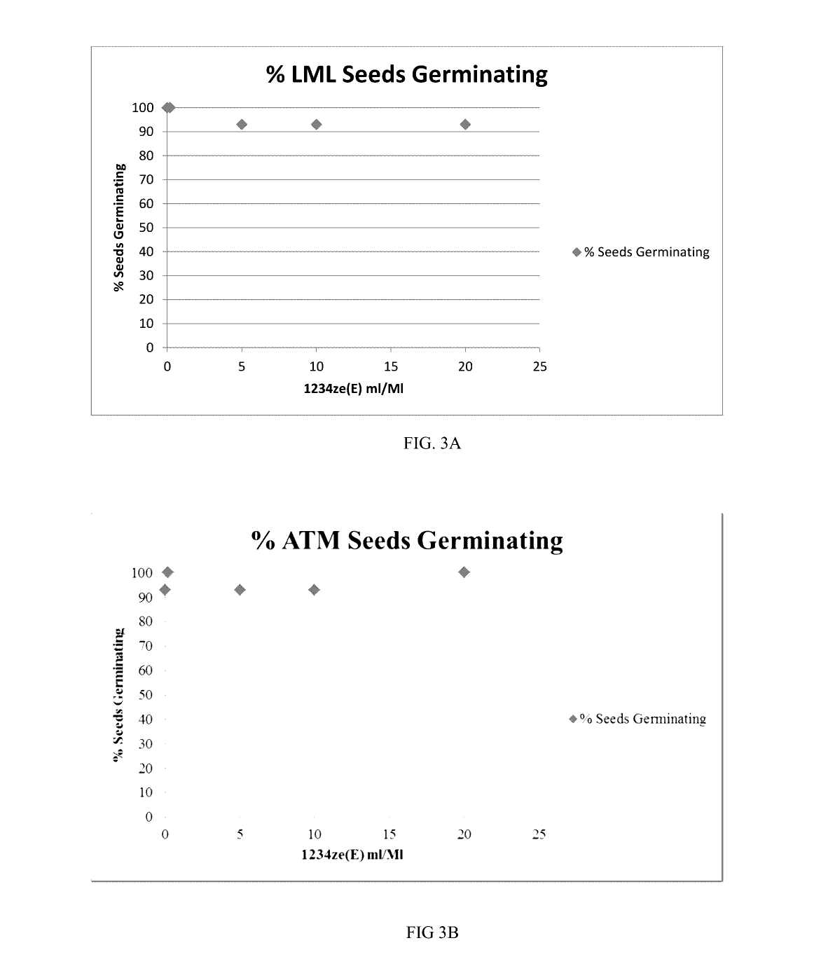

As can be seen from the results above, the 1234ze(E) showed little or no fumigation activity toward either the Abutilon theophrastic Medik seeds or the Loliium multiflorum Lam seeds in these tests. This is illustrated by the graphs of the data illustrated in FIGS. 3A and 3B.

### Comparative Example 4

The procedure described in Example 1 is repeated, expect that the gaseous material added was HFO-1234ze(Z). The results are reported in Table 4 below.

TABLE 4
Germination Results for cis-HFO-1234ze

| | SEED GERMINATION | |
|---|---|---|
| | Abutilon | Loliium |
| | theophrastic | multiflorum |
| Volume 1234ze(Z) | Medik. | Lam. |

| μl | μl/Ml dry soil | Number | % | Number | % |
|---|---|---|---|---|---|
| 10 | 0.2 | 15 | 100 | 14 | 93 |
| 250 | 5 | 14 | 93 | 14 | 93 |
| 500 | 10 | 15 | 100 | 14 | 93 |
| 1000 | 20 | 14 | 93 | 15 | 100 |

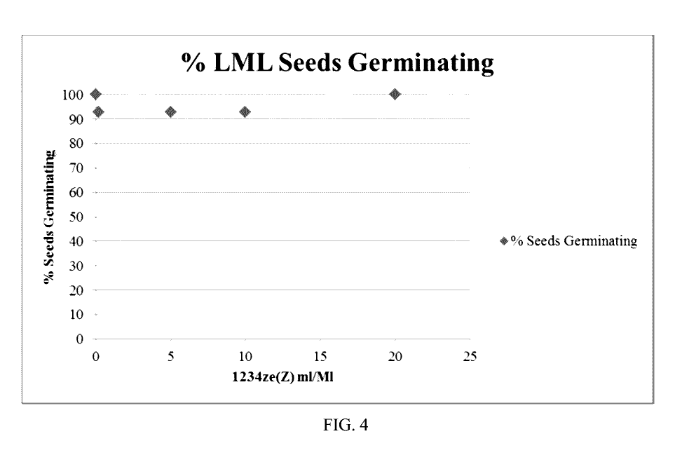

As can be seen from the results above, the 1234ze(E) showed little or no fumigation activity toward either the Abutilon theophrastic Medik seeds or the Loliium multiflorum Lam seeds in these tests. This is illustrated by the graphs of the data illustrated in FIG. 4.

### Example 2

A soil field containing unwanted plant species is provided. A fumigant composition comprising an active component consisting essentially of HFCO-1233zd(Z) is applied to the field by shank injection. At least 50% of the unwanted species contained in the soil field are killed or fail to germinate.

### Example 3

A soil field containing unwanted plant species is provided. A fumigant composition comprising an active component consisting essentially of HFCO-1233zd(Z) is applied to the field by drip irrigation. At least 50% of the unwanted species contained in the soil field are killed or fail to germinate.

### Example 4

A soil field containing unwanted plant species is provided. A fumigant composition comprising an active component consisting essentially of HFCO-1233zd(Z) is applied to the field by by tractor mounted injectors. At least 50% of the unwanted species contained in the soil field are killed or fail to germinate.

### Example 5

A soil field containing unwanted plant species is provided. A fumigant composition comprising an active component consisting essentially of HFCO-1233zd(Z) is applied to the field as a gas through lay-flat tubing. At least 50% of the unwanted species contained in the soil field are killed or fail to germinate.

### Example 6

A soil field containing unwanted plant species is provided. A fumigant composition comprising an active component consisting essentially of HFCO-1233zd(Z) is applied to the field manually by injection. At least 50% of the unwanted species contained in the soil field are killed or fail to germinate.

### Example 7

A soil field containing seeds from the broadleaf species Abutilon theophrastic Medik. or velvet leaf and the grass weed species Loliium multiflorum Lam. or Italian rye grass is provided. A fumigant composition comprising an active component consisting essentially of HFCO-1233zd(Z) is applied to the field by shank injection. At least 50% of the seeds from the above-noted species contained in the soil field fail to germinate.

### Example 8

A soil field containing seeds from the broadleaf species Abutilon theophrastic Medik. or velvet leaf and the grass weed species Loliium multiflorum Lam. or Italian rye grass is provided. A fumigant composition comprising an active component consisting essentially of HFCO-1233zd(Z) is applied to the field by drip irrigation. At least 50% of the seeds from the above-noted species contained in the soil field fail to germinate.

### Example 9

A soil field containing seeds from the broadleaf species Abutilon theophrastic Medik. or velvet leaf and the grass weed species Loliium multiflorum Lam. or Italian rye grass is provided. A fumigant composition comprising an active component consisting essentially of HFCO-1233zd(Z) is applied to the field by by tractor mounted injectors. At least 50% of the seeds from the above-noted species contained in the soil field fail to germinate.

### Example 10

A soil field containing seeds from the broadleaf species Abutilon theophrastic Medik. or velvet leaf and the grass weed species Loliium multiflorum Lam. or Italian rye grass is provided. A fumigant composition comprising an active component consisting essentially of HFCO-1233zd(Z) is applied to the field as a gas through lay-flat tubing. At least 50% of the seeds from the above-noted species contained in the soil field fail to germinate.

### Example 11

A soil field containing seeds from the broadleaf species Abutilon theophrastic Medik. or velvet leaf and the grass weed species Loliium multiflorum Lam. or Italian rye grass is provided. A fumigant composition comprising an active component consisting essentially of HFCO-1233zd(Z) is applied to the field manually by injection. At least 50% of the seeds from the above-noted species contained in the soil field fail to germinate.

What is claimed is:

1. A method of reducing or eradicating undesirable species from an area containing the undesirable species comprising:
(a) contacting the area with a fumigant composition comprising: (i) one or more active compounds and (ii) optionally carrier for said one or more active compounds, said one or more active compounds comprising at least about 10% by weight of cis-1-chloro-3,3,3-trifluoropropene (HFCO-123zd(Z)) and being essentially free of methyl iodide.

2. The method of claim 1, wherein the undesirable species include one or more of weeds, nematodes or pathogens.

3. The method of claim 1, wherein the area is soil in a field.

4. The method of claim 3, wherein the contacting step comprises contacting soil with the fumigant composition.

5. The method of claim 4, wherein contacting soil comprises contacting soil via drip irrigation.

6. The method of claim 5, wherein contacting soil comprises contacting soil via shank injection.

7. The method of claims 1 wherein the fumigant composition is in gaseous form.

8. The method of claim 1 wherein the fumigant composition is in aqueous form.

9. The method of claim 1 wherein the one or more active compounds further comprise at least one of hexafluoropropene, chloropicrin, 1,3-dichloropropene, dimethyl disulfide, propylene oxide or metham sodium.

10. The method of claim 9 wherein the fumigant composition further comprises at least one surfactant.

11. The method of claim 1 wherein the fumigant composition further comprises at least one odorant.

12. The method of claim 1 wherein said fumigant composition consists essentially of HFCO-1233zd(Z) and a surfactant.

13. The method of claim 1 wherein said fumigant composition comprises a carrier solvent having at least one three or four-carbon hydrofluorocarbon olefin, provided that the fumigant composition does not contain any substantial amount of halogenated alkene compounds having a terminal, unsaturated carbon with two halogen substituents.

14. The method of claim 4 wherein said one or more active compounds (i) comprise (i) cis-1-chloro-3,3,3-trifluoropropene (HFCO-123zd(Z)) in an amount of at least about 40% by weight based on the weight of the active compounds; and (ii) are essentially free any components that have a high LD50 toxicty.

15. The method of claim 14 wherein said contacting step is effective to ensure that less than about 20% by number of the weed seeds present in the soil at the time of application germinate.

16. The method of claim 14 wherein said contacting step is effective to ensure that less than about 10% by number of the weed seeds present in the soil at the time of application germinate

17. The method of claim 14 wherein said contacting step is effective to ensure that less than about 5% by number of the weed seeds present in the soil at the time of application germinate.

18. The method of claim 14 wherein said contacting step comprises applying said fumigant composition to the soil in an amount greater than about 10 microliliter (10-6 liters) of fumigant composition per milliliter of soil (10-3 liters), (μl/ml).

19. The method of claim 14 wherein said contacting step comprises applying said fumigant composition to the soil in an amount greater than about 15 microliliter (10-6 liters) of fumigant composition per milliliter of soil (10-3 liters), (μl/ml).

20. The method of claim 14 wherein said contacting step comprises applying said fumigant composition to the soil in an amount of from greater than about 5 μl/ml to less than about 20 μl/ml.

21. A method of reducing or eradicating undesirable species from soil comprising:contacting the soil with a fumigant composition comprising: (i) one or more active compounds and (ii) optionally carrier for said one or more active compounds, wherein said one or more active compounds consists essentially of cis-1-chloro-3,3,3-trifluoropropene (HFCO-1233zd(Z)).

22. A fumigant composition comprising:
(a) one or more active compounds comprising, based on the weight of the total active compounds in the composition, at least about 10% by weight of cis-1-chloro-3,3,3-trifluoropropene (HFCO-123zd(Z)) and being essentially free of methyl iodide and essentially free of any compound having a high LD50 toxicty; and
(b) carrier for said one or more active compounds.

23. The fumigant composition of claim 22 wherein said one or more active compounds comprise less than 1000 ppm of any components that has a high LD50 toxicty.

24. The fumigant composition of claim 22 wherein said one or more active compounds comprise less than 1000 ppm of any component that has an LD50 toxicty of less than about 150 mg/kg (oral, rat).

25. The fumigant composition of claim 22 wherein said one or more active compounds comprise less than 500 ppm of any component that has an LD50 toxicty of less than about 150 mg/kg (oral, rat).
